(19) United States
(12) Patent Application Publication
(10) Pub. No.: US 2026/0064525 A1
(43) Pub. Date: Mar. 5, 2026

(54) HOST MANAGED DATA RECOVERY OPERATIONS

(71) Applicant: Micron Technology, Inc., Boise, ID (US)

(72) Inventor: David Aaron PALMER, Boise, ID (US)

(21) Appl. No.: 19/264,338

(22) Filed: Jul. 9, 2025

Related U.S. Application Data
(60) Provisional application No. 63/687,976, filed on Aug. 28, 2024.

(51) Int. Cl. G06F 11/10

(52) U.S. Cl. CPC G06F 11/1004

(57) ABSTRACT

In some implementations, a host system may provide, to a memory system, a request for a data recovery configuration of the memory system, the data recovery configuration indicating a quantity of one or more data units associated with a data recovery operation and a parity ratio associated with the data recovery operation. The host system may generate parity information for data associated with a write operation based on the data recovery configuration.

### CROSS-REFERENCE TO RELATED APPLICATION

This Patent application claims priority to U.S. Provisional Patent Application No. 63/687,976, filed on Aug. 28, 2024, entitled “HOST MANAGED DATA RECOVERY OPERATIONS,” and assigned to the assignee hereof. The disclosure of the prior Application is considered part of and is incorporated by reference into this Patent Application.

### TECHNICAL FIELD

The present disclosure generally relates to memory devices, memory device operations, and, for example, to host managed data recovery operations.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., not-and (NAND) memory and not-or (NOR) memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source.

### BRIEF DESCRIPTION OF THE DRAWINGS

FIG. 1 is a diagram illustrating an example system capable of host managed data recovery operations.

FIGS. 2A through 2D are diagrams of an example of host managed data recovery operations.

FIG. 3 is a flowchart of an example method associated with host managed data recovery operations.

FIG. 4 is a flowchart of an example method associated with host managed data recovery operations.

### DETAILED DESCRIPTION

Some memory systems, such as systems that include one or more NAND memory devices, may employ data recovery operations to enhance data reliability, such as a redundant array of independent NAND (RAIN) scheme. Such data recovery operations may include storing data and parity information associated with the data across multiple memory locations. For example, a memory system may partition the data into one or more codewords. In some cases, the memory system may calculate the parity information by combining the one or more codewords, such as by performing one or more exclusive-or (XOR) operations to generate the parity information. If one of the codewords becomes corrupted, then the memory system may recover the corrupted codeword by combining the other codewords and the parity information (e.g., by performing one or more XOR operations to generate a corrected codeword corresponding to the corrupted codeword).

However, managing such a data recovery operation may use significant system resources, such as processing resources used to perform the one or more XOR operations, as well as volatile memory resources (e.g., space within a buffer of the memory system, such as an SRAM array). Further, a memory system may maintain multiple sets of parity information for respective groups of codewords stored across a portion of the memory system, such as a page, a block, a plane, and/or a die. Using multiple sets of parity information may allow the memory system to correct corrupted data in the case that the entire portion experiences a failure, but may further increase the resource usage of the data recovery operation.

Some implementations described herein enable host managed data recovery operations. For example, a host system may provide, to a memory system, a request for a data recovery configuration. Based on, in response to, or otherwise associated with obtaining the request, the memory system may provide the data recovery configuration to the host system. As described in greater detail elsewhere herein, a data recovery configuration of the memory system may include information associated with a data recovery operation for one or more data units stored to the memory system, such as a degree of parallelism for the data recovery operation and/or a parity ratio for the data recovery operation, among other examples.

The host system may generate parity information for data associated with a write operation based on the data recovery configuration. For example, the host system may partition the data into one or more data units to be stored across one or more storage units, such as one or more pages, one or more blocks, one or more planes, and/or one or more memory dies. In some implementations, the quantity of data units within each storage unit may correspond to the degree of parallelism of the data recovery operation. The host system may generate a quantity of storage units corresponding to the degree of parallelism.

In some examples, the host system may selectively store the parity information to the memory system or refrain from storing the parity information to the memory system (e.g., discard the parity information) based on one or more parity storage conditions, such as the reliability of programming operations associated with the memory system, availability of storage space in the memory system, and/or the quantity of resources used to generate the parity information, among other examples. For example, if the host system determines that the likelihood of errors occurring as part of storing and/or reading the data from the memory system is relatively small, then the host system may discard the parity information. Alternatively, if the host system determines that the likelihood of errors occurring as part of storing and/or reading the data from the memory system is relatively large, then the host system may store the parity information to the memory system.

As a result, by enabling host managed data recovery operations, the host system may offload processing associated with calculating the parity information from the memory system, which may free up processing resources of the memory system and thus improve performance of the memory system. Additionally, such offloading may reduce the amount of buffer space (e.g., space within an SRAM) of the memory system that would otherwise be used as part of generating the parity information. The reduced amount of buffer space may allow for a reduced total size of the SRAM, which may reduce manufacturing costs and/or manufacturing complexities. Additionally, because the host system may have greater processing capabilities than the memory system, generating the parity information at the host system may enable more sophisticated error correction algorithms, which may increase the reliability of data associated with the host system and the memory system. Further, by selectively storing the parity information, the host system may increase the efficiency of the data recovery operation. For example, by refraining from storing parity information in cases in which data is unlikely to be corrupted, the host system may increase the space available in the memory system. Such space may be used to store other data, and thus improve performance of the memory system.

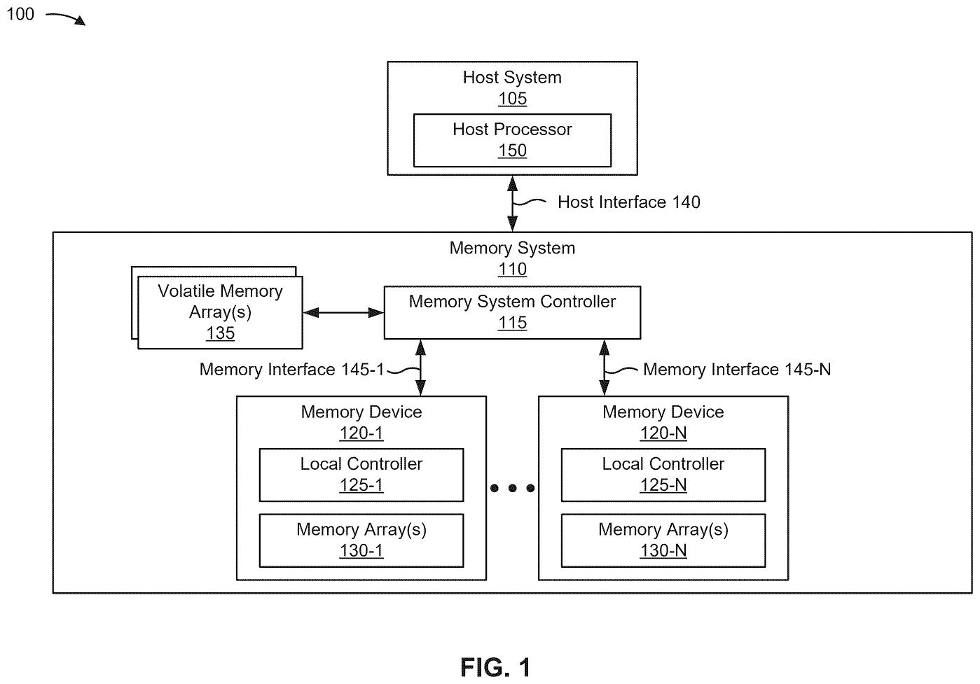

FIG. 1 is a diagram illustrating an example system 100 capable of host managed data recovery operations. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off, and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, and/or a DIMM interface.

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, one or more systems, devices, apparatuses, components, and/or controllers of FIG. 1 may be configured to: provide, to a memory system, a request for a data recovery configuration of the memory system, the data recovery configuration indicating a quantity of one or more data units associated with a data recovery operation and a parity ratio associated with the data recovery operation; obtain, from the memory system, the data recovery configuration; and generate parity information for data associated with a write operation based on the data recovery configuration.

In some implementations, one or more systems, devices, apparatuses, components, and/or controllers of FIG. 1 may be configured to: obtain, from a host system, a request for a data recovery configuration of the memory apparatus, the data recovery configuration indicating a quantity of data units associated with a data recovery operation and a parity ratio associated with the data recovery operation; and provide, to the host system, the data recovery configuration.

In some implementations, one or more systems, devices, apparatuses, components, and/or controllers of FIG. 1 may be configured to: communicate, via a host interface and to a memory apparatus, a request for a data recovery configuration of the memory apparatus, the data recovery configuration indicating a quantity of one or more data units associated with a data recovery operation and a parity ratio associated with the data recovery operation; communicate via the host interface and to a host system, the data recovery configuration; and generate, at the host system, parity information for data associated with a write operation based on the data recovery configuration.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

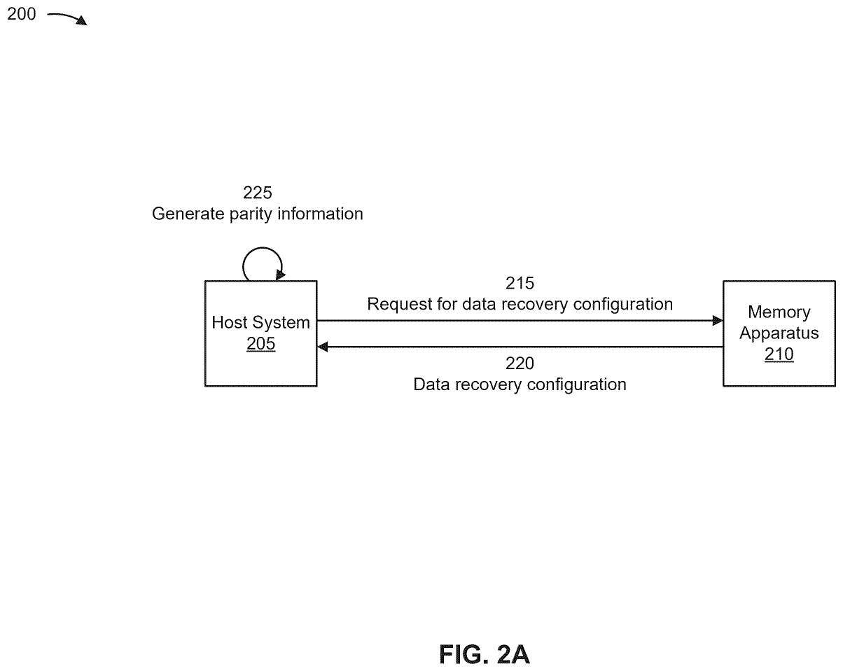

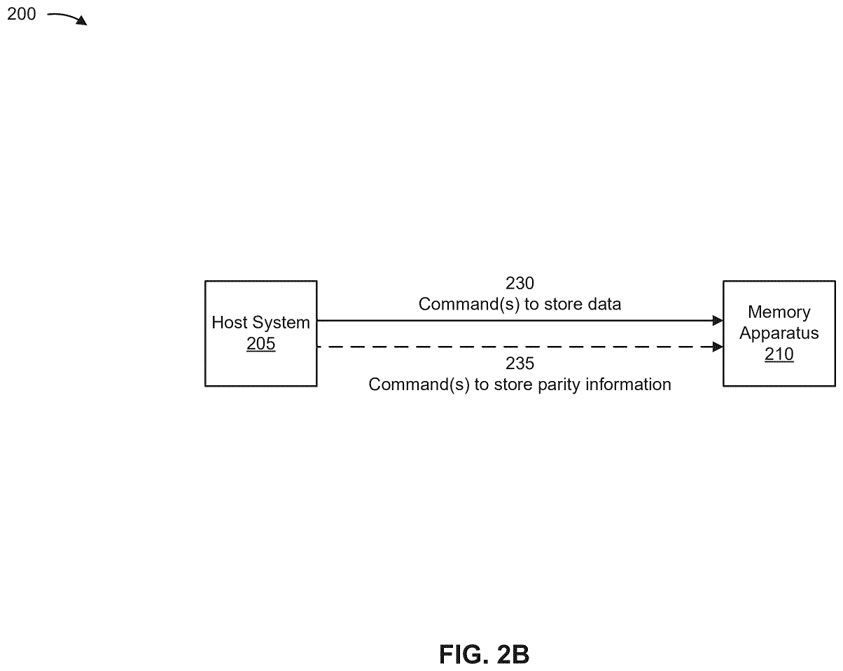

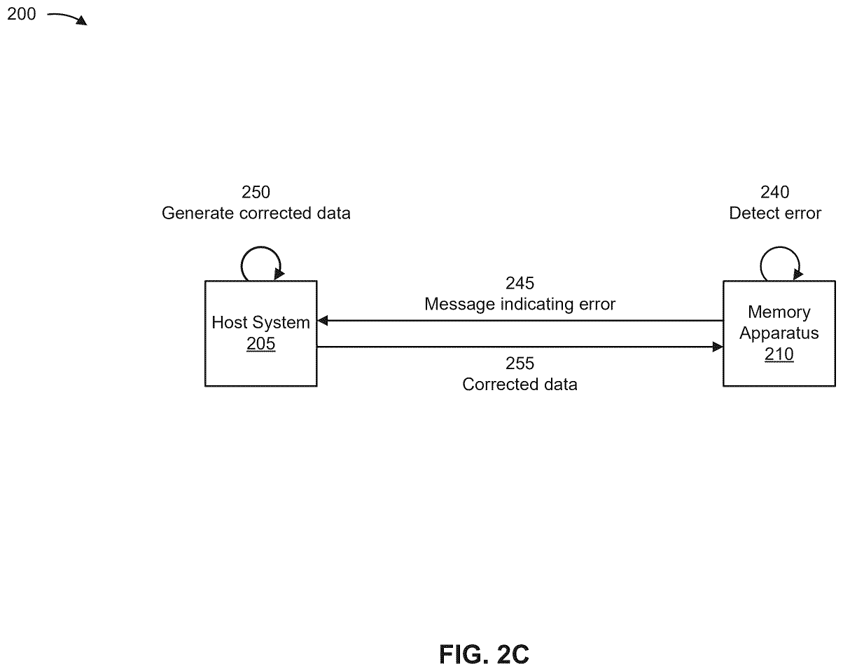

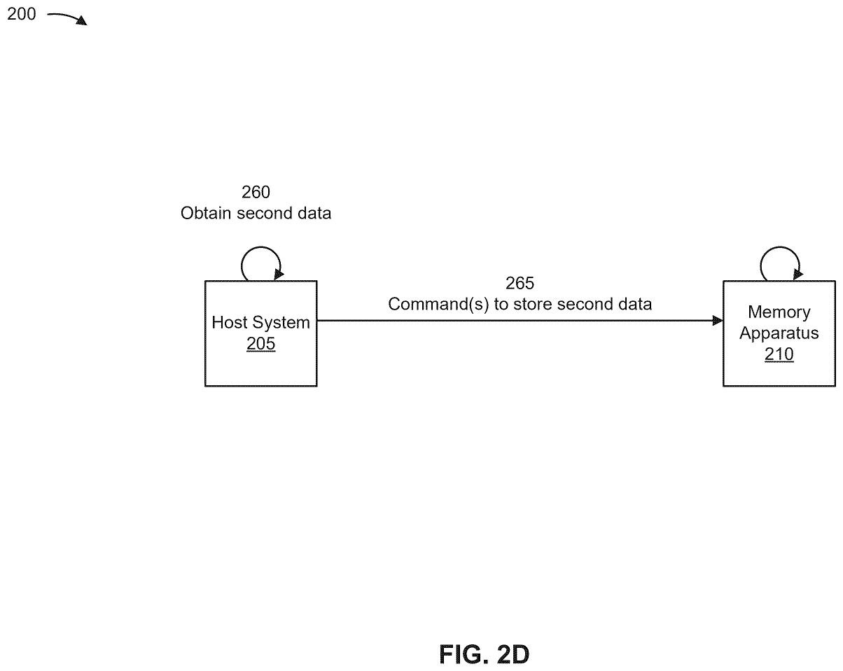

FIGS. 2A through 2D are diagrams of an example 200 of host managed data recovery operations. The operations described in connection with FIGS. 2A through 2D may be performed by the memory system 110 and/or one or more components of the memory system 110, such as the memory system controller 115, one or more memory devices 120, and/or one or more local controllers 125. Additionally, or alternatively, the operations described in connection with FIGS. 2A through 2D may be performed by the system 100, the host system 105, one or more components of the host system 105 (e.g., the host processor 150), and/or the host interface 140.

As shown in FIGS. 2A through 2D, the example 200 may include a host system 205 and a memory apparatus 210. The host system 205 may be the host system 105. The memory apparatus 210 may be, or may include, the memory system 110, one or more memory devices 120, and/or one or more controllers (e.g., the memory system controller 115 and/or one or more local controllers 125).

As shown in FIG. 2A, and by reference number 215, the host system 205 may provide, to the memory apparatus 210, a request for a data recovery configuration. For example, the host system 205 may communicate the request for the data recovery configuration to the memory apparatus 210 via a host interface, such as the host interface 140. In some implementations, the host system 205 may communicate the request as part of an initial configuration of the memory apparatus 210. Additionally, or alternatively, the host system 205 may communicate the request at other times of operation of the memory apparatus 210 (e.g., periodically, as part of a reconfiguration procedure). In some implementations, the request for the data recovery configuration may be a query for a device descriptor. For example, the request may indicate that the memory apparatus 210 is to provide the device descriptor to the host system 205. The device descriptor may be a data structure that includes information associated with the characteristics and/or capabilities of the memory apparatus 210. For example, the device descriptor may include the data recovery configuration, as well as other information, such as configuration parameters and/or operational protocols, among other examples.

A data recovery configuration of the memory apparatus 210 may include information associated with a data recovery operation for one or more data units stored to the memory apparatus 210. As described herein, “data unit” refers to a continuous range of memory of the memory apparatus 210, such as a continuous sequence of memory cells of a word line, one or more sequential physical addresses of the memory apparatus 210 (e.g., a set of word lines having consecutive physical addresses), and/or one or more sequential logical addresses (e.g., logical block addresses (LBAs)) of the memory apparatus 210.

In some examples, the memory apparatus 210 may store the data units across a storage unit of the memory apparatus 210. As described herein, “storage unit” refers to level of granularity across which the data units are stored. For example, a storage unit may be one or more pages of the memory apparatus 210, one or more blocks of memory cells of the memory apparatus 210, one or more planes of the memory apparatus 210, one or more dies of the memory apparatus 210, and/or one or more memory devices (e.g., memory devices 120) of the memory apparatus 210. In some examples, a storage unit may correspond to a level of granularity that may be susceptible to data corruption. For example, data corruption may affect a particular portion of the memory apparatus 210, such as a single page, block, or plane.

The data recovery configuration may indicate a degree of parallelism for the data recovery operation. As described herein, the degree of parallelism of a data recovery operation is the quantity of data units within a storage unit of the memory system. In some implementations, data units within a storage unit may be ordered (e.g., indexed) according to the degree of parallelism. For example, a first data unit of the storage unit may be associated with a first index (e.g., an ordinal “1”), a second data unit consecutive with the first data unit may be associated with a second index consecutive with the first index (e.g., an ordinal “2”), and so on, up to the degree of parallelism. Additionally, the data recovery configuration may indicate a parity ratio for the data recovery operation. As described herein, “parity ratio” refers to the quantity of data units to be protected by a parity unit (e.g., a ratio between the quantity of data units and the quantity of parity units).

The degree of parallelism may indicate the quantity of independent parity units calculated for a given storage unit. For example, to generate parity units for a quantity of storage units corresponding to the parity ratio of a data recovery configuration, the host system 205 may combine (e.g., by applying one or more XOR operations) data units of a given index. Said another way, to generate a first parity unit, the host system 205 may combine each data unit of the storage units having the first index. To generate a second parity unit, the host system 205 may combine each data unit of the storage units having the second index, and so on, up to the degree of parallelism of the data recovery configuration.

In some implementations, the memory apparatus 210 may support multiple data recovery configurations. For example, the memory apparatus 210 may include multiple types of blocks memory cells, such as one or more blocks of single-level cells (SLCs) in which each memory cell may be configured to store a single bit, one or more blocks of multi-level cells (MLCs) in which each memory cell may be configured to store two bits, one or more blocks of triple-level cells (TLCs) in which each memory cell may be configured to store three bits, and/or one or more blocks of quad-level cells (QLCs) in which each memory cell may be configured to store four bits, among other examples. In such implementations, the memory apparatus 210 may manage a respective data recovery configuration for each type of block of memory cell. Additionally, in such examples, the request for the data recovery configuration may indicate the type of block memory cell for the data recovery configuration.

As shown by reference number 220, the memory apparatus 210 may provide, and the host system 205 may obtain, the data recovery configuration. For example, based on, in response to, or otherwise associated with receiving the request from the host system 205, the memory apparatus 210 may generate the data recovery configuration, for example by determining the data recovery configuration and/or retrieving the data recovery configuration, such as by retrieving the data recovery configuration from hardware identification, controller firmware, interface protocols, or other configuration information. The memory apparatus 210 may communicate the data recovery configuration to the host system 205. In some examples, the data recovery configuration may include an array, in which the size of the array (e.g., the quantity of elements of the array) indicates the degree of parallelism. Additionally, or alternatively, the data recovery configuration may include one or more information elements, such as fields of the device descriptor associated with the memory apparatus 210, that indicate the degree of parallelism of the data recovery operation, the parity ratio of the data recovery operation, the storage unit of the data recovery operation, and/or the size of a data unit of the data recovery operation.

As shown reference number 225, the host system 205 may generate parity information for data associated with a write operation based on the data recovery configuration. For example, the host system 205 may partition the data into one or more data units to be stored across one or more storage units. In some implementations, the quantity of data units within each storage unit may correspond to the degree of parallelism of the data recovery operation. The host system 205 may generate a quantity of storage units corresponding to the degree of parallelism. For example, for a quantity of storage units corresponding to the parity ratio, the host system 205 may generate a first parity unit using the first indexed data unit in each storage unit, may generate a second parity unit using the second indexed data unit in each storage unit, and so on, up to the degree of parallelism of the data recovery configuration.

By generating the parity information at the host system 205, the host system 205 may offload processing associated with calculating the parity information from the memory apparatus 210, which may free up processing resources of the memory apparatus 210. Additionally, such offloading may reduce the amount of buffer space (e.g., space within an SRAM) of the memory apparatus 210 that would otherwise be used as part of generating the parity information. Further, the reduced amount of buffer space may allow for a reduced total size of the SRAM, which may reduce manufacturing costs and/or manufacturing complexities. Additionally, because the host system 205 may have greater processing capabilities than the memory apparatus 210, generating the parity information at the host system 205 may enable more sophisticated error correction algorithms, which may increase the reliability of data associated with the host system 205 and the memory apparatus 210.

As shown in FIG. 2B by reference number 230, the host system 205 may provide, and the memory apparatus 210 may obtain, one or more commands (e.g., write commands) to store the data in accordance with the data recovery configuration. For example, the host system 205 may determine respective address ranges (e.g., physical address ranges, logical address ranges, and/or one or more LBAs) for the one or more data units. The address range for a given data unit may correspond to the index of the given data unit. For example, a first address range for a first data unit having a first index in a storage unit may correspond to a first physical address range of the storage unit, a second address range for a second data unit having a second index consecutive with the first index in the storage unit may correspond to a second physical address range of the storage unit consecutive with the first physical address range, and so on.

Based on, in response to, or otherwise associated with obtaining the one or more commands to store the data, the memory apparatus 210 may store the data in accordance with the address ranges determined by the host system 205. In some implementations, after storing the data, the memory apparatus 210 may provide, and the host system 205 may obtain, an acknowledgement message indicating that the data has been successfully stored.

The host system 205 may selectively store the parity information to the memory apparatus 210 or refrain from storing the parity information to the memory apparatus 210 (e.g., discard the parity information) based on one or more parity storage conditions, such as the reliability of programming operations associated with the memory apparatus 210, availability of storage space in the memory apparatus 210, and/or the quantity of resources used to generate the parity information, among other examples. As used herein, “selectively” performing an operation means to either perform the operation or refrain from performing the operation. For example, selectively performing an operation based on whether a condition is satisfied means that the operation is performed if the condition is satisfied and that the operation is not performed if the condition is not satisfied (or vice versa). Thus, selectively performing an operation may include determining whether to perform the operation and then either performing the operation or refraining from performing the operation based on that determination. As used herein, “selectively” performing a first operation or a second operation means to perform either the first operation or the second operation. For example, selectively performing a first operation or a second operation based on whether a condition is satisfied means that the first operation is performed if the condition is satisfied and that the second operation is performed if the condition is not satisfied (or vice versa). Thus, selectively performing a first operation or a second operation may include determining whether to perform either the first operation or the second operation and then performing either the first operation or the second operation based on that determination.

For example, if the host system 205 determines that the likelihood of errors occurring as part of storing and/or reading the data from the memory apparatus 210 is relatively small, then the host system 205 may discard the parity information (e.g., after obtaining an acknowledgment that the memory apparatus 210 has successfully programmed the data). In such examples, the host system 205 may further refrain from generating the parity information, such as by omitting operations described in connection with reference number 225. By selectively storing the parity information, the host system 205 may increase the efficiency of the data recovery operation. For example, by refraining from storing parity information in cases in which data is unlikely to be corrupted, the host system 205 may increase the space available in the memory apparatus 210. Such space may be used to store other data, and thus improve performance of the memory apparatus 210.

Alternatively, if the host system 205 determines that the likelihood of errors occurring as part of storing and/or reading the data from the memory apparatus 210 is relatively large, then the host system 205 may store the parity information to the memory apparatus. In such examples, as shown by reference number 235, the host system 205 may provide, and the memory apparatus 210 may obtain, one or more commands to store the parity information associated with the data. For example, the host system 205 may determine respective address ranges (e.g., physical address ranges, logical address ranges, and/or one or more LBAs) for the one or more parity units. The address range for a given parity unit may correspond to the index of the data units used to generate the given parity unit. For example, a first address range for a first parity unit associated with first index may correspond to a first physical address range, a second address range for a second parity unit associated with a second index consecutive with the first index in the storage unit may correspond to a second physical address range of the storage unit consecutive with the first physical address range, and so on. By determining address ranges for the data units and the parity information, the host system 205 may be enabled to perform a data recovery operation to recover a corrupted data unit, as described in greater detail elsewhere herein.

As shown by FIG. 2C, and reference number 240, the memory apparatus 210 may detect one or more errors in the data. For example, the memory apparatus 210 may, using one or more error control schemes managed by the memory apparatus 210 (e.g., a single error correction (SEC) scheme, a single error correction double error detection (SECDED) scheme, a cyclic redundancy check (CRC) scheme, among other examples), detect the errors. In some examples, as shown by reference number 245, the memory apparatus 210 may provide, and the host system 205 may obtain, a message indicating that the data includes the one or more errors. In some examples, the message may indicate one or more data units that include an error.

Based on, in response to, or otherwise associated with obtaining the message, the host system 205 may determine how to address the one or more errors, such as by selectively performing a data recovery operation or refraining from performing the data recovery operation based on one or more recovery conditions associated with the data. For example, the host system 205 may consider the reliability of programming operations associated with the memory apparatus 210, the availability of storage space in the memory apparatus 210, the success rate of prior data recovery attempts, the impact of data errors on system performance, and/or the accessibility of alternative data sources, among other examples.

If the host system 205 determines to perform the data recovery operation, then, as shown by reference number 250, the host system 205 may generate corrected data. For example, to correct a corrupted data unit indicated by the message, the host system 205 may retrieve (e.g., via one or more read commands) one or more data units and a parity unit associated with the corrupted data unit (e.g., data units and a parity unit having a same index in accordance with the data recovery configuration). The host system 205 may combine the data units and the parity unit (e.g., by applying one or more XOR operations) to generate a corrected data unit. Accordingly, as shown by reference number 255, the host system 205 may provide, and the memory apparatus 210 may obtain, one or more commands to store the corrected data unit.

Alternatively, if the host system 205 determines to refrain from performing the data recovery operation, then, as shown in FIG. 2D by reference number 260, the host system 205 may obtain second data associated with the corrupted data. For example, if the host system 205 has access to data files associated with the corrupted data from an external source, such as an external server, then the host system 205 may obtain (e.g., via a communication network between the host system 205 and the external source) a copy of the data files. In such examples, as shown by reference number 265, the host system 205 may provide, and the memory apparatus 210 may obtain, one or more commands to store the data files (e.g., in accordance with the data recovery configuration). Alternatively, the host system 205 and/or the memory apparatus 210 may determine to mark the corrupted data as uncorrectable. For example, the host system 205 and/or the memory apparatus 210 may determine that the data includes an uncorrectable error correction code (UECC). In such examples, the memory apparatus 210 may store a value (e.g., may store metadata associated with the data) indicating that the data includes a UECC.

As indicated above, FIGS. 2A through 2D are provided as examples. Other examples may differ from what is described with regard to FIGS. 2A through 2D.

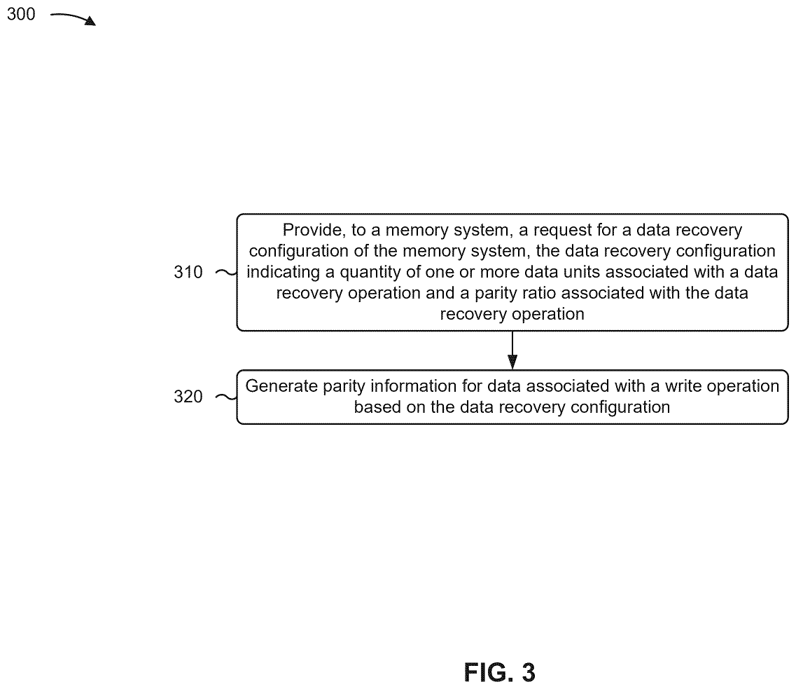

FIG. 3 is a flowchart of an example method 300 associated with host managed data recovery operations. In some implementations, a host system (e.g., the host system 105 and/or the host system 205) may perform or may be configured to perform the method 300. In some implementations, another device or a group of devices separate from or including the host system (e.g., the memory system 110, the memory system controller 115, one or more memory devices 120, one or more volatile memory arrays 135, the memory apparatus 210, and/or the host interface 140) may perform or may be configured to perform the method 300. Additionally, or alternatively, one or more components of the host system (e.g., the host processor 150) may perform or may be configured to perform the method 300. Thus, means for performing the method 300 may include the host system and/or one or more components of the host system. Additionally, or alternatively, a non-transitory computer-readable medium may store one or more instructions that, when executed by the host system, cause the host system to perform the method 300.

As shown in FIG. 3, the method 300 may include providing, to a memory system, a request for a data recovery configuration of the memory system, the data recovery configuration indicating a quantity of one or more data units associated with a data recovery operation and a parity ratio associated with the data recovery operation (block 310). As further shown in FIG. 3, the method 300 may include generating parity information for data associated with a write operation based on the data recovery configuration (block 320).

The method 300 may include additional aspects, such as any single aspect or any combination of aspects described below and/or described in connection with one or more other methods or operations described elsewhere herein.

In a first aspect, the method 300 includes providing, to the memory system, one or more commands indicating that the memory system is to store the data and the parity information, the one or more commands further indicating a first address range for the data and a second address range for the parity information.

In a second aspect, alone or in combination with the first aspect, the method 300 includes determining the second address range based on the data recovery configuration, the second address range including one or more logical block addresses.

In a third aspect, alone or in combination with one or more of the first and second aspects, the method 300 includes providing, to the memory system, a command indicating that the memory system is to store second data, obtaining, from the memory system, an acknowledgment message indicating that the second data is stored, and refraining from generating second parity information for the second data based on obtaining the acknowledgement message.

In a fourth aspect, alone or in combination with one or more of the first through third aspects, the method 300 includes obtaining, from the memory system, a message indicating an error associated with the data, and selectively, based on a determination of whether a recovery condition associated with the data is satisfied, performing the data recovery operation or refraining from performing the data recovery operation.

In a fifth aspect, alone or in combination with one or more of the first through fourth aspects, the recovery condition is satisfied, and the method 300 includes obtaining, from the memory system, the data and the parity information, generating, using the data and the parity information and based on the data recovery configuration, corrected data, and storing the corrected data to the memory system.

In a sixth aspect, alone or in combination with one or more of the first through fifth aspects, the recovery condition is not satisfied, and the method 300 includes refraining from performing the data recovery operation, obtaining second data associated with the data, and storing the second data to the memory system.

In a seventh aspect, alone or in combination with one or more of the first through sixth aspects, the one or more data units correspond to one or more portions of a page of the memory system.

In an eighth aspect, alone or in combination with one or more of the first through seventh aspects, the one or more data units correspond to one or more pages of the memory system.

In a ninth aspect, alone or in combination with one or more of the first through eighth aspects, a first data unit of the one or more data units corresponds to a first page of a first plane of the memory system, and a second data unit of the one or more data units corresponds to a second page of a second plane of the memory system.

In a tenth aspect, alone or in combination with one or more of the first through ninth aspects, the request includes a query for a device descriptor of the memory system, the device descriptor including the data recovery configuration.

In an eleventh aspect, alone or in combination with one or more of the first through tenth aspects, the method 300 includes providing, to the memory system, a second request for a second data recovery configuration, where the data recovery configuration is associated with a first type of memory cells, and where the second data recovery configuration associated with a second type of memory cells different than the first type, and obtaining, from the memory system, the second data recovery configuration.

In a twelfth aspect, alone or in combination with one or more of the first through eleventh aspects, the method 300 includes performing one or more XOR operations using the one or more data units, where the parity information corresponds to a result of the one or more XOR operations.

In a thirteenth aspect, alone or in combination with one or more of the first through twelfth aspects, the data recovery operation is a RAIN operation.

Although FIG. 3 shows example blocks of a method 300, in some implementations, the method 300 may include additional blocks, fewer blocks, different blocks, or differently arranged blocks than those depicted in FIG. 3. Additionally, or alternatively, two or more of the blocks of the method 300 may be performed in parallel. The method 300 is an example of one method that may be performed by one or more devices described herein. These one or more devices may perform or may be configured to perform one or more other methods based on operations described herein.

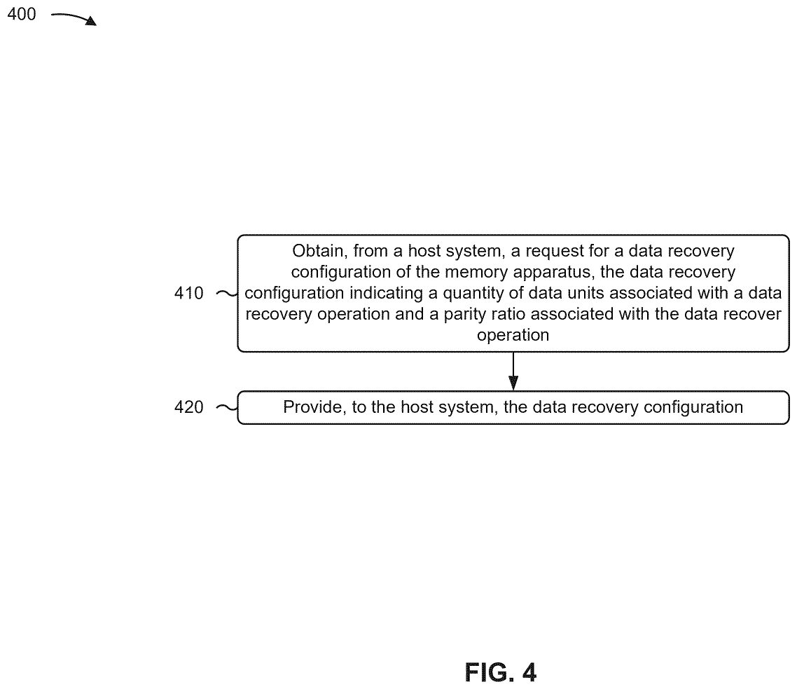

FIG. 4 is a flowchart of an example method 400 associated with host managed data recovery operations. In some implementations, a memory apparatus (e.g., the memory system 110 and/or the memory apparatus 210) may perform or may be configured to perform the method 400. In some implementations, another device or a group of devices separate from or including the memory apparatus (e.g., the host system 105, the host interface 140, and/or the host system 205) may perform or may be configured to perform the method 400. Additionally, or alternatively, one or more components of the memory apparatus (e.g., the memory system controller 115, one or more memory devices 120, one or more local controllers 125, on or more memory arrays 130, and/or one or more volatile memory arrays 135) may perform or may be configured to perform the method 400. Thus, means for performing the method 400 may include the memory apparatus and/or one or more components of the memory apparatus. Additionally, or alternatively, a non-transitory computer-readable medium may store one or more instructions that, when executed by the memory apparatus, cause the memory apparatus to perform the method 400.

As shown in FIG. 4, the method 400 may include obtaining, from a host system, a request for a data recovery configuration of the memory apparatus, the data recovery configuration indicating a quantity of data units associated with a data recovery operation and a parity ratio associated with the data recovery operation (block 410). As further shown in FIG. 4, the method 400 may include providing, to the host system, the data recovery configuration (block 420).

The method 400 may include additional aspects, such as any single aspect or any combination of aspects described below and/or described in connection with one or more other methods or operations described elsewhere herein.

In a first aspect, the method 400 includes obtaining, from the host system, one or more commands indicating that the memory apparatus is to store data and parity information associated with the data, the one or more commands further indicating a first address range for the data and a second address range for the parity information.

In a second aspect, alone or in combination with the first aspect, the method 400 includes identifying an error associated with the data, providing, to the host system, a message indicating the error, providing, to the host system, the data and the parity information, and obtaining, from the host system, corrected data, the corrected data generated by the host system using the data and the parity information.

In a third aspect, alone or in combination with one or more of the first and second aspects, the method 400 includes identifying an error associated with the data, providing, to the host system, a message indicating the error, and storing metadata indicating the error to the memory apparatus.

In a fourth aspect, alone or in combination with one or more of the first through third aspects, the data recovery operation is a RAIN operation.

In a fifth aspect, alone or in combination with one or more of the first through fourth aspects, the method 400 includes refraining, based on providing the data recovery configuration to the host system, from generating parity information associated with the data recovery operation.

Although FIG. 4 shows example blocks of a method 400, in some implementations, the method 400 may include additional blocks, fewer blocks, different blocks, or differently arranged blocks than those depicted in FIG. 4. Additionally, or alternatively, two or more of the blocks of the method 400 may be performed in parallel. The method 400 is an example of one method that may be performed by one or more devices described herein. These one or more devices may perform or may be configured to perform one or more other methods based on operations described herein.

In some implementations, a host system includes one or more controllers configured to: provide, to a memory system, a request for a data recovery configuration of the memory system, the data recovery configuration indicating a quantity of one or more data units associated with a data recovery operation and a parity ratio associated with the data recovery operation; obtain, from the memory system, the data recovery configuration; and generate parity information for data associated with a write operation based on the data recovery configuration.

In some implementations, a memory apparatus includes one or more controllers configured to: obtain, from a host system, a request for a data recovery configuration of the memory apparatus, the data recovery configuration indicating a quantity of data units associated with a data recovery operation and a parity ratio associated with the data recovery operation; and provide, to the host system, the data recovery configuration.

In some implementations, a system includes a host system; a memory apparatus; a host interface between the host system and the memory apparatus; and one or more controllers configured to: communicate, via the host interface and to the memory apparatus, a request for a data recovery configuration of the memory apparatus, the data recovery configuration indicating a quantity of one or more data units associated with a data recovery operation and a parity ratio associated with the data recovery operation; communicate, via the host interface and to the host system, the data recovery configuration; and generate, at the host system, parity information for data associated with a write operation based on the data recovery configuration.

In some implementations, a method includes providing, by a host system and to a memory system, a request for a data recovery configuration of the memory system, the data recovery configuration indicating a quantity of one or more data units associated with a data recovery operation and a parity ratio associated with the data recovery operation; generating, by the host system, parity information for data associated with a write operation based on the data recovery configuration.

In some implementations, a method includes obtaining, by a memory apparatus and from a host system, a request for a data recovery configuration of the memory apparatus, the data recovery configuration indicating a quantity of data units associated with a data recovery operation and a parity ratio associated with the data recovery operation; and providing, by the memory apparatus and to the host system, the data recovery configuration.

In some implementations, an apparatus includes means for providing, to a memory system, a request for a data recovery configuration of the memory system, the data recovery configuration indicating a quantity of one or more data units associated with a data recovery operation and a parity ratio associated with the data recovery operation; means for generating parity information for data associated with a write operation based on the data recovery configuration.

In some implementations, an apparatus includes means for obtaining, from a host system, a request for a data recovery configuration of the memory apparatus, the data recovery configuration indicating a quantity of data units associated with a data recovery operation and a parity ratio associated with the data recovery operation; and means for providing, to the host system, the data recovery configuration.

The foregoing disclosure provides illustration and description but is not intended to be exhaustive or to limit the implementations to the precise forms disclosed. Modifications and variations may be made in light of the above disclosure or may be acquired from practice of the implementations described herein.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A host system, comprising:
one or more controllers configured to:
provide, to a memory system, a request for a data recovery configuration of the memory system, the data recovery configuration indicating a quantity of one or more data units associated with a data recovery operation and a parity ratio associated with the data recovery operation;
obtain, from the memory system, the data recovery configuration; and
generate parity information for data associated with a write operation based on the data recovery configuration.

2. The host system of claim 1, wherein the one or more controllers are further configured to:
provide, to the memory system, one or more commands indicating that the memory system is to store the data and the parity information, the one or more commands further indicating a first address range for the data and a second address range for the parity information.

3. The host system of claim 2, wherein the one or more controllers are further configured to:
determine the second address range based on the data recovery configuration, the second address range comprising one or more logical block addresses.

4. The host system of claim 1, wherein the one or more controllers are further configured to:
provide, to the memory system, a command indicating that the memory system is to store second data;
obtain, from the memory system, an acknowledgment message indicating that the second data is stored; and
refrain from generating second parity information for the second data based on obtaining the acknowledgement message.

5. The host system of claim 1, wherein the one or more controllers are further configured to:
obtain, from the memory system, a message indicating an error associated with the data; and
selectively, based on a determination of whether a recovery condition associated with the data is satisfied, perform the data recovery operation or refrain from performing the data recovery operation.

6. The host system of claim 5, wherein the recovery condition is satisfied and wherein, to perform the data recovery operation, the one or more controllers are configured to:
obtain, from the memory system, the data and the parity information;
generate, using the data and the parity information and based on the data recovery configuration, corrected data; and
store the corrected data to the memory system.

7. The host system of claim 5, wherein the recovery condition is not satisfied and wherein the one or more controllers are further configured to:
refrain from performing the data recovery operation;
obtain second data associated with the data; and
store the second data to the memory system.

8. The host system of claim 1, wherein the one or more data units correspond to one or more portions of a page of the memory system.

9. The host system of claim 1, wherein the one or more data units correspond to one or more pages of the memory system.

10. The host system of claim 1, wherein a first data unit of the one or more data units corresponds to a first page of a first plane of the memory system, and wherein a second data unit of the one or more data units corresponds to a second page of a second plane of the memory system.

11. The host system of claim 1, wherein the request comprises a query for a device descriptor of the memory system, the device descriptor including the data recovery configuration.

12. The host system of claim 1, wherein the one or more controllers are further configured to:
provide, to the memory system, a second request for a second data recovery configuration, wherein the data recovery configuration is associated with a first type of memory cells and wherein the second data recovery configuration associated with a second type of memory cells different than the first type; and
obtain, from the memory system, the second data recovery configuration.

13. The host system of claim 1, wherein, to generate the parity information, the one or more controllers are further configured to:
perform one or more exclusive-or (XOR) operations using the one or more data units, wherein the parity information corresponds to a result of the one or more XOR operations.

14. The host system of claim 1, wherein the data recovery operation is a redundant array of independent not-and (RAIN) operation.

15. A memory apparatus, comprising:
one or more controllers configured to:
obtain, from a host system, a request for a data recovery configuration of the memory apparatus, the data recovery configuration indicating a quantity of data units associated with a data recovery operation and a parity ratio associated with the data recovery operation; and
provide, to the host system, the data recovery configuration.

16. The memory apparatus of claim 15, wherein the one or more controllers are further configured to:
obtain, from the host system, one or more commands indicating that the memory apparatus is to store data and parity information associated with the data, the one or more commands further indicating a first address range for the data and a second address range for the parity information.

17. The memory apparatus of claim 16, wherein the one or more controllers are further configured to:
identify an error associated with the data;
provide, to the host system, a message indicating the error;
provide, to the host system, the data and the parity information; and
obtain, from the host system, corrected data, the corrected data generated by the host system using the data and the parity information.

18. The memory apparatus of claim 16, wherein the one or more controllers are further configured to:
identify an error associated with the data;
provide, to the host system, a message indicating the error; and
store metadata indicating the error to the memory apparatus.

19. The memory apparatus of claim 15, wherein the data recovery operation is a redundant array of independent not-and (RAIN) operation.

20. The memory apparatus of claim 15, wherein the one or more controllers are further configured to:
refrain, based on providing the data recovery configuration to the host system, from generating parity information associated with the data recovery operation.

21. A system, comprising:
a host system;
a memory apparatus;
a host interface between the host system and the memory apparatus; and
one or more controllers configured to:
communicate, via the host interface and to the memory apparatus, a request for a data recovery configuration of the memory apparatus, the data recovery configuration indicating a quantity of one or more data units associated with a data recovery operation and a parity ratio associated with the data recovery operation;
communicate, via the host interface and to the host system, the data recovery configuration; and
generate, at the host system, parity information for data associated with a write operation based on the data recovery configuration.

22. The system of claim 21, wherein the one or more controllers are further configured to:
communicate, via the host interface and the memory apparatus, one or more commands indicating that the memory apparatus is to store the data and the parity information, the one or more commands further indicating a first address range for the data and a second address range for the parity information.

23. The system of claim 22, wherein the one or more controllers are further configured to:
determine, by the host system, the second address range based on the data recovery configuration, the second address range comprising one or more logical block addresses.

24. The system of claim 21, wherein the one or more controllers are further configured to:
communicate, via the host interface and to the memory apparatus, a command indicating that the memory apparatus is to store second data;
communicate, via the host interface and to the host system, an acknowledgment message indicating that the second data is stored; and
refrain, by the host system, from generating second parity information for the second data based on obtaining the acknowledgement message.

25. The system of claim 21, wherein the one or more controllers are further configured to:
communicate, via the host interface and to the host system, a message indicating an error associated with the data; and
selectively, based on a determination of whether a recovery condition associated with the data is satisfied, perform the data recovery operation or refrain from performing the data recovery operation.
